(19) United States
(12) Patent Application Publication
(10) Pub. No.: US 2009/0048108 A1
(43) Pub. Date: Feb. 19, 2009

(54) Herbicide

(76) Inventors: Rodney Mitchell Innes, Te Kouma Coromandel (NZ); Von Walter Johnson, Mount Roskill Auckland (NZ)

Correspondence Address: BELL & ASSOCIATES, 58 West Portal Avenue No. 121, SAN FRANCISCO, CA, 94127, US

(21) Appl. No.: 12/080,162

(22) Filed: Apr. 1, 2008

Related U.S. Application Data
(60) Provisional application No. 60/921,525, filed on Apr. 2, 2007.

(51) Int. Cl. A01N 31/00; A01N 61/00; A01P 13/00

(52) U.S. Cl. 504/118

(57) ABSTRACT

A herbicide mixture comprising alpha terpinol and tall oil is herein described.

### PRIOR APPLICATION INFORMATION

The instant application claims the benefit of US Provisional Patent Application 60/921,525, filed Apr. 2, 2007.

### BACKGROUND OF THE INVENTION

PCT Application WO 97/16975 teaches a herbicidal composition having as an active ingredient a terpene compound, a terpene derivative or an essential oil comprising a terpene compound or a terpene derivative. It is stated that the herbicidal compositions therein described must be sprayed over a substantial portion of the above-ground part of the plant in order to have effect.

U.S. Pat. No. 6,759,370 (INNES) teaches a herbicidal combination of monoterpene alcohols and fatty acid soaps, where the fatty acid soap may be derived from the reaction of a tall oil with an alkali. The inventors also state that the added fatty acid soap either (or both) enhances the effect of the primary active components or acts as an active component disrupting plant function. The foam may have a half-life of 3-5 minutes. It is further stated that the herbicide is non-selective but is most effective against broad leaf plants.

U.S. Pat. No. 5,407,899 teaches a surfactant carrier mixture with an aqueous copper complex in emulsified form which provides rapid algaecidal and herbicidal activity, preferably on water-based plants. The surfactant carrier mixture comprises a ‘terpene’ as the wetting agent and a water-soluble salt of a higher fatty acid as the anionic surfactant.

U.S. Pat. No. 5,728,672 teaches a pine oil cleaning concentrate comprising pine oil and a non-ionic surfactant. Optional additives include germicidal agents and foaming agents.

U.S. Pat. No. 5,753,593 teaches an aquatic herbicide comprising a natural oil containing a ‘high’ terpene and a surfactant. Suggested natural oils include pine oil, orange oil, grapefruit oil and lemon oil. Suitable surfactants include salts of fatty acids. In use, the herbicide is sprayed directly to the surface of the target aquatic vegetation.

U.S. Pat. No. 5,763,468 teaches a bactericidal composition comprising at least one terpene alcohol and at least one bactericidal acidic surfactant, typically a carboxylic acid or a phosphoric ester. As discussed at column 3, line 65 to column 4, line 6, the inventors saw an unexpected synergy between pine oil and the surfactants. The composition possesses bactericidal activity against both gram-negative and gram-positive bacteria.

U.S. Pat. No. 5,948,731 teaches that amine aliphatic salts of substituted or unsubstituted saturated or unsaturated fatty acids have herbicidal activity.

U.S. Pat. No. 5,998,335 teaches a herbicidal composition comprising pine oil and tea tree oil or eucalyptus oil. This patent also discloses that the herbicidal formulation may be in a variety of forms, including sprays, liquids, wettable powders, oily solutions, emulsions, dusts, granules and fumigants. This patent also states that many other natural oils were tested and shown to have no herbicidal activity including coconut oil and a number of vegetable oils, including corn oil, sunflower oil and safflower oil.

### SUMMARY OF THE INVENTION

According to a first aspect of the invention, there is provided a herbicide mixture comprising alpha terpinol and tall oil.

According to a second aspect of the invention, there is provided a method of applying a herbicide comprising:

providing a mixture comprising alpha terpinol and tall oil; and

spraying the mixture onto a quantity of soil,

wherein a herbicidal vapour is released by the mixture over a period of time greater than 10 minutes.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is the use of organic fatty acids and/or alcohols in solid, liquid or gas form either on its own or with a carrier. Suitable sources of the fatty acids/alcohols include plant extracted oils like pine oil and coconut oil and carbon chains above C8. Suitable carriers include water or nut, palm or vegetable oil.

In a preferred embodiment, there is provided a herbicide comprising alpha terpinol or terpene alcohol as the active ingredient. In other embodiments, the herbicide comprises terpene alcohol or alpha-terpinol, tall oil and KOH. As discussed below, in preferred embodiments, the herbicide may be used as a concentrate and may be diluted in water or in other carriers, for example, oils. Preferably, the oils are natural oils, for example, but by no means limited to, canola oil, sunflower oil, corn oil, other suitable vegetable oils, palm oils, nut oils and the like.

As discussed below, the inventors have discovered that the herbicidal activity of pine oil is due to the alpha terpineol fraction only. Accordingly, this represents a significant improvement over the prior art, as raw materials high in alpha terpinol can be preferentially selected and/or synthetic alpha terpinol can be generated for use as the active ingredient of the herbicide. As will be appreciated by one of skill in the art, the composition of pine oil is very complex and uneconomical to copy synthetically. However, the discovery that alpha terpinol is the active ingredient enables the preparation of herbicides that are specifically enriched for alpha terpinol, for example, either by using starting materials that have higher natural levels of alpha terpinol or by removing other compounds within the raw material, thereby enriching the alpha terpinol by subtraction and/or by taking steps during processing of the starting or raw materials into the herbicide such that alpha terpinol is preferentially retained or stabilized in its active form, as discussed herein.

Accordingly, in some embodiments of the invention, the herbicide is characterized in that the herbicide comprises at least 70% or at least 75% or at least 80% or at least 85% alpha terpinol. This is in contrast with pine oil formulations which use whole pine oil and consequently lower percentages of alpha terpinol as alpha terpinol is not the sole alcohol in pine oil.

It is noted that while pine oil has a boiling point of 200-220° C., alpha terpineol or alpha terpinol has a flash point of approximately 80° C. Accordingly, taking care during processing to ensure that alpha terpinol retention is maximized will result in a more effective herbicide, as discussed herein. Furthermore, such a herbicide can be diluted to a greater extent and still retain efficacy, as discussed below.

In embodiments wherein the herbicide is intended to be used with a non-water carrier, the components used in the preparation of the herbicide may be saponified. As discussed above, the saponification is preferably carried out under conditions such that alpha terpinol is retained, for example, at temperatures below the boiling point of alpha terpinol.

In a preferred embodiment, the herbicide comprises a mixture of 21-80% terpine alcohol or alpha terpineol and 8-66% tall oil. As discussed below, the specific ratio depends on what weed types are being targeted. For example, to kill grasses, a lower alpha terpineol and higher tall oil concentration is suitable whereas for broad leaf weeds, lower tall oil and higher alpha terpinol concentrations are suitable.

It is further of note that the herbicide described herein differs from INNES in that sodium hydroxide is not added for converting tall oil to a soap.

As discussed below, it has also been discovered that the herbicide described herein has powerful seed inhibiting activity and this activity is active in the vapour released from the herbicide. Furthermore, the vapour is efficacious at all stages of seed germination/development. For example, alpha terpinol vapor is effective against freshly germinated or about to germinate seeds and stops the seeds from developing further.

As will be appreciated by one of skill in the art, this represents as significant discovery as it was previously believed that pine oil herbicides needed to be applied to a significant above-ground portion of the plant. However, the inventors' discovery has led to the discovery that the herbicide can be applied onto the soil or into over-turned soil, as discussed below. That is, as discussed below, once applied to the soil, the herbicide releases a vapour which is effective at stopping undesired growth. Thus, the desired period of herbicidal activity can be obtained by selecting the appropriate carrier having the desired release characteristics, as discussed below.

For example, when the herbicide is applied as a spray in a water-based formulation, the release of the herbicide as a vapour is subject to the evaporation time of the water. Similarly, when the herbicide is applied as a spray in an oil-based carrier, the release of the vapour is subject to the evaporation of the oil. Accordingly, oils having higher boiling points than water will retain the herbicidal vapour for a longer period of time. As such, in a preferred embodiment of the invention, the mixture releases a herbicidal vapour for greater than 10 minutes.

The herbicide is also suitable for application directly onto weeds or the like, as discussed below. As discussed herein, on application, the herbicidal mixture is composed of small, uniform droplets. As a result of this arrangement, the herbicidal mixture wets and spreads on the leaves as quickly as possible.

As a result, the herbicide is effective both on weed seeds and the associated above ground plants. It is further of note that the seeds can be either on the ground or on the weed.

Furthermore, the herbicide mixture rapidly emulsifies in water.

As discussed above, U.S. Pat. No. 6,759,370 (Innes) teaches the need to use a foam for delivery so as to increase the time of contact with the plant. As will be apparent to one of skill in the art, foams are a mixture of liquid and air and accordingly the use of a foam-formulation would promote rapid vapour release.

Accordingly, in some embodiments, the herbicide further comprises a vapour retaining additive or adhering additive, for example, cellulose, which effectively acts as a ‘glue’ and improves the ‘stickability’ of the herbicide, meaning that the herbicide is in contact with the target vegetation for a longer period of time and releases the vapour over a longer period of time. As will be appreciated by one of skill in the art, herbicides comprising both the vapour retaining additive and an oil carrier may have very long vapour releasing profiles.

In some embodiments, the herbicide as described herein is applied directly to the soil, for example, on top of the soil or directly into the soil, for example, when the soil is being overturned, for example, by farm machinery such as rotary hoes, farrowing devices, top soil lifting apparatuses and the like. As discussed herein, the release characteristics of the herbicidal formulations result in the active ingredient(s) permeating through the soil for a greater period of time, thereby providing much longer lasting herbicidal activity.

As will be appreciated by one of skill in the art, the ability to target seeds significantly improves the effectiveness of the herbicide. Previously, as discussed above, it was believed that only leafy regions of the plant could be targets for the herbicide. Furthermore, it was believed that steps needed to be taken to prolong the residency of the herbicide on the leafy regions of the plant, as discussed above. Surprisingly, the inventors have discovered that vapour forms of the herbicide can be used to target seeds, as discussed herein.

As discussed below, it has been demonstrated that the seedicidal activity of the herbicide is effective with alcohol rates as low as 0.5% diluted with the water application rate. As discussed above, this is the direct result of the inventors' discovery that alpha terpinol is the active ingredient in pine oil, meaning that herbicides with much higher levels of active ingredient (alpha terpinol) can now be prepared. As a result, a much more effective herbicide can be produced which in turn can be diluted to a greater extent and still maintain efficacy than previously believed.

It is of note that the efficacy for the seedicidal activity can be variable due to varying resistances of seed cases on seed heads and penetration depths of soils to access seeds underground. However, in these embodiments, the herbicide may be mixed with an oil carrier as discussed above which in turn produces a composition that is more effective at penetrating seed cases and therefore a more effective herbicide.

The invention will now be described by way of examples. However, the invention is not necessarily limited to or by the examples.

### Formulation Using Trial Pine Oil and Tall Oil

Different concentrations of Tall oil (Pine chem. 317) with terpene alcohol (Pine oil 530) and alpha terpineol (Pine Oil 593) were evaluated to determine if increased control activity of board leaf weeds and grasses can be achieved.

Treatments No 1
15% dilution.
(sample containers with red caps)

| | Sample A | | | | | | | |
|---|---|---|---|---|---|---|---|---|
| | % w/w | Sample B % | Sample C % | Sample D % | Sample E % | Sample F % | Sample G % | Sample H % |
| Pinechem 530 | 80% 12.00 | 71% 10.76 | 63% 9.51 | 55% 8.27 | 46% 7.02 | 38% 5.78 | 30% 4.53 | 21% 3.29 |
| Pinechem 317 | 8.3% 1.25 | 16% 2.49 | 24% 3.74 | 33% 4.98 | 41% 6.23 | 49% 7.47 | 58% 8.72 | 66% 9.96 |
| Caustic mix | 0.66 | 0.66 | 0.66 | 0.66 | 0.66 | 0.66 | 0.66 | 0.66 |
| Water | 1.10 | 1.10 | 1.10 | 1.10 | 1.10 | 1.10 | 1.10 | 1.10 |
| Water | 85.00 | 85.00 | 85.00 | 85.00 | 85.00 | 85.00 | 85.00 | 85.00 |

15% dilution
(sample containers with white caps)

| | Sample O | | | | | | | |
|---|---|---|---|---|---|---|---|---|
| | % w/w | Sample P % | Sample Q % | Sample R % | Sample S % | Sample T % | Sample U % | Sample V % |
| Pinechem 593 | 12.00 | 10.76 | 9.51 | 8.27 | 7.02 | 5.78 | 4.53 | 3.29 |
| Pinechem 317 | 1.25 | 2.49 | 3.74 | 4.98 | 6.23 | 7.47 | 8.72 | 9.96 |
| Caustic mix | 0.66 | 0.66 | 0.66 | 0.66 | 0.66 | 0.66 | 0.66 | 0.66 |
| Water | 1.10 | 1.10 | 1.10 | 1.10 | 1.10 | 1.10 | 1.10 | 1.10 |
| Water | 85.00 | 85.00 | 85.00 | 85.00 | 85.00 | 85.00 | 85.00 | |

### Application Detail

Pump home garden sprayer with a fan nozzle approx pressure 30 psi 2.5 bar.
All applications applied at 15% formulation in 85% water.
The pump sprayer was cleaned between applications
Rate 1000 litre per hectare due to dense weed growth

### Spraying Conditions

Temperature 27° Celsius no wind

### Weed Species

Bay Plenty general summer grasses and broad leaf weeds at mature stages as seed heads were present.
Plantain, summer grass, night shade, fathen
Clover red, dock, couch, cocksfoot, Paspalan

### Summary of Results

Application of Pine Chem 530 Sample E, F, G gave total grass control at 15% concentration
Applications of Pine Chem 593 Samples T, U, V gave total grass control at 15% concentration
Range depends on what weed types you are being treated. For example, to kill grasses, a low pine and high tall oil concentration is suitable whereas for broad leaf weeds lower tall oil higher pine concentration are suitable.

No 2 Trial to evaluate 10% fractions using promising fractions from first
assessment at 15%.
Comparison of Pinechem 317, 530 & 593 2.3.05
10% dilution.
(sample containers with red caps)

| | Sample A | | |
|---|---|---|---|
| | % w/w | Sample B % | Sample C % |
| Pinechem 530 | 8.00 | 7.17 | 6.34 |
| Pinechem 317 | 0.83 | 1.66 | 2.49 |
| Caustic mix | 0.44 | 0.44 | 0.44 |
| Water | 0.73 | 0.73 | 0.73 |
| Water | 90.00 | 90.00 | 90.00 |

10% dilution
(sample containers with white caps)

| | Sample O | | | | | |
|---|---|---|---|---|---|---|
| | % w/w | Sample P % | Sample Q % | Sample R % | Sample S % | Sample T % |
| Pinechem 593 | 8.00 | 7.17 | 6.34 | 5.51 | 4.68 | 3.85 |
| Pinechem 317 | 0.83 | 1.66 | 2.49 | 3.32 | 4.15 | 4.98 |
| Caustic mix | 0.44 | 0.44 | 0.44 | 0.44 | 0.44 | 0.44 |
| Water | 0.73 | 0.73 | 0.73 | 0.73 | 0.73 | 0.73 |
| Water | 90.00 | 90.00 | 90.00 | 90.00 | 90.00 | 90.00 |

10% dilution
(sample containers with green caps)

| | Sample W |
|---|---|
| | % w/w |
| Pinechem 530 | 3.59 |
| Pinechem 593 | 2.34 |
| Pinechem 317 | 2.91 |
| Caustic mix | 0.44 |
| Water | 0.73 |
| Water | 90.00 |

Application at 1000 l/ha
Applied the same as trial 1 and with similar weather conditions following application difference lower rate per hectare

### Summary Results Trial 2

Sample T at 10% dilution shown above gave total grass control only but no effect on board leaf weeds.
3. Seed destruction—two sub groups A) seeds on above ground or on weed seed heads B) seeds below the soil surface.

### Method

Petri dishes containing 50 seeds placed on damp filter paper were placed in a environmentally controlled germination cabinet.

The control was water placed to wet filter paper

Other dishes had different concentrations of the herbicides as discussed below placed on the filter paper.

It was found that 100% death was achieved to all White Radish seed tested as they failed to germinate while the control achieved 90 plus germination.

Concentrations below 1% dilution of the herbicide still gave some control of seed but this appeared to decrease down to 0.25% dilution.

### Example 2

### Screening of Pine Fractions for Seed Killing Activity

### Bioassay/Screening of Pine Fractions for Seed Killing Activity.

Assay: Petri plate assay with paper towel at controlled temperature
Seeds: Chick Pea (Cicer artietinum) 15 seeds, Fenugreek (Trigonella foenum-graecum LINN) 0.7 gm and Brown Mustard (Brassica juncea) 0.7 gm.

### Temperature: 30° C.

Pine Fractions tested:

### PC500, PC530, PC560, PC569, PC593, PC600, PC620.

Formulation: same as BWC Formulation B with above mentioned Pine fractions.
Treatments: A,C,E—Seeds soaked in 10% formulation for 1 min.
B,D,F—1 ml of 10% formulation applied to paper

### Summary:

Bio Chick Pea Seed Killing activity of Pine fractions

| Treat- | | | | No of | |
|---|---|---|---|---|---|
| ment | Pine | Fraction | No of | seeds | % |
| No | Chem | Description | Seeds | germinated | Germination |
| 1A | Control | | 15 | 15 | 100 |
| 1B | Control | | 15 | 15 | 100 |
| 2A | PC 500 | Alpha Pinene | 15 | 15 | 100 |
| 2B | PC 500 | Alpha Pinene | 15 | 15 | 100 |
| 3A | PC 530 | Terpene | 15 | 0 | 0 |
| | | Alcohol | | | |
| 3B | PC 530 | Terpene | 15 | 0 | 0 |
| | | Alcohol | | | |
| 4A | PC560 | Dipentene | 15 | 15 | 100 |
| 4B | PC 560 | Dipentene | 15 | 15 | 100 |
| 5A | PC 569 | Terpinolene | 15 | 15 | 100 |
| 5B | PC 569 | Terpinolene | 15 | 15 | 100 |
| 6A | PC 593 | Alpha Terpineol | 15 | 0 | 0 |
| 6B | PC 593 | Alpha Terpineol | 15 | 0 | 0 |
| 7A | PC 600 | Beta Pinene | 15 | 15 | 100 |
| 7B | PC 600 | Beta Pinene | 15 | 15 | 100 |
| 8A | PC 620 | Myrcene | 15 | 15 | 100 |
| 8B | PC 620 | Myrcene | 15 | 15 | 100 |

Bio Fenugreek Seed killing activity of Pine Fraction:

| Treatment | Pine | Fraction | No of seeds | |
|---|---|---|---|---|
| No | Chem | description | Germinated | % Germination |
| 1C | Control | | All | 100 |
| 1D | Control | | All | 100 |
| 2C | PC 500 | Alpha Pinene | All | 100 |
| 2D | PC 500 | Alpha Pinene | All | 100 |
| 3C | PC 530 | Terpene Alcohol | None | 0 |
| 3D | PC 530 | Terpene Alcohol | None | 0 |
| 4C | PC560 | Dipentene | All | 100 |
| 4D | PC 560 | Dipentene | All | 100 |
| 5C | PC 569 | Terpinolene | All | 100 |
| 5D | PC 569 | Terpinolene | All | 100 |
| 6C | PC 593 | Alpha Terpineol | None | 0 |
| 6D | PC 593 | Alpha Terpineol | None | 0 |
| 7C | PC 600 | Beta Pinene | All | 100 |
| 7D | PC 600 | Beta Pinene | All | 100 |
| 8C | PC 620 | Myrcene | All | 100 |
| 8D | PC 620 | Myrcene | All | 100 |

Bio Mustard seed killing activity of Pine Fractions:

| Treatment | Pine | Fraction | No of seeds | |
|---|---|---|---|---|
| No | Chem | description | Germinated | % Germination |
| 1E | Control | | All | 100 |
| 1F | Control | | All | 100 |
| 2E | PC 500 | Alpha Pinene | All | 100 |
| 2F | PC 500 | Alpha Pinene | All | 100 |
| 3E | PC 530 | Terpene Alcohol | None | 0 |
| 3F | PC 530 | Terpene Alcohol | None | 0 |
| 4E | PC560 | Dipentene | All | 100 |
| 4F | PC 560 | Dipentene | All | 100 |
| 5E | PC 569 | Terpinolene | All | 100 |
| 5F | PC 569 | Terpinolene | All | 100 |
| 6E | PC 593 | Alpha Terpineol | None | 0 |
| 6F | PC 593 | Alpha Terpineol | None | 0 |
| 7E | PC 600 | Beta Pinene | All | 100 |
| 7F | PC 600 | Beta Pinene | All | 100 |
| 8E | PC 620 | Myrcene | All | 100 |
| 8F | PC 620 | Myrcene | All | 100 |

### Conclusions:

1. PC 530 and PC 593 which contains 85-93% Terpene alcohol showed very powerful seed killing activity against all three diverse types of seeds tested. Seed killing activity was same in the case of seeds soaked in the formulation (Treatment A,C,E) and seeds exposed to paper containing the formulation (Treatments B,D,F).
2. Other pine fractions containing Alpha pinene, Dipentene, Terpinolene, Beta pinene and Myrcene did not show any seed killing activity against all three types of seeds. Formulations containing all these fractions gave healthy seed germination and sprouting comparable to the control treatment.
3. Based on this study we can confirm that seed killing activity by inhibiting seeds to germinate is due to Terpene Alcohol (Terpineol) only and no other pine fractions has a ability to kill the seeds.

### Effect of Vapour Phase of Individual Components on Seed Killing.

This experiment was designed to study effect of vapour phase on the seed germination by fragmentation/separation of individual components.

### Experimental Set Up:

Experiment was carried out in Plastic containers with lid at 30° C.
Paper towel at the bottom added with 10 ml of water
In the centre of the bottom of plastic container small plastic cap added with 8 ml of respective formulation.
Seed: Chick Pea (Cicer arietinum)
11 chickpea seeds soaked in water overnight per treatment

### Formulations:

### Control: Water

Tall Oil: PC300 (Hexion Ltd.), amount equivalent of 20% of Formulation B.
Pine Oil: PC593 (Hexion Ltd.), amount equivalent of 20% of Formulation B.

### 20% of Formulation B

### Results:

Results were noted after 4 Days

| | | No of | | | |
|---|---|---|---|---|---|
| | | Seeds | % | Ave.Root | Ave. Shoot |
| No | Treatment | Germinated | Germination | Length (mm) | Length (mm) |
| 1 | Control | 11 | 100 | 45 | 19 |
| 2 | Tall Oil | 11 | 100 | 46 | 18 |
| | (PC300) | | | | |
| 3 | Pine Oil | 0 | 0 | — | — |
| | (PC593) | | | | |
| 4 | B | 0 | 0 | — | — |

### Observation:

All seeds in the container of control and Tall oil germinated and showed very healthy rooting and shooting where as seeds in the Pine Oil and Formulation B containers did not germinate.

### Conclusions:

1. 0% seed germination in Pine Oil and Formulation B treatments confirm that the seed killing activity is due to vapour phase and terpineol vapour is the active ingredient.
2. Vapor generated by Pine Oil concentration in Formulation B is lethal for the desired seed killing activity.
3. As Tall Oil is only fatty acids and without vapour, showed very healthy seed germination with rooting and shooting at par with Control.
4. The fragmentation of the components of the product clearly shows which component is the active for the seed killing activity.

### Further Studies on the Effect of Vapour Phase on Seed Germination/Health.

### Experimental Setup:

Experiment was carried out in plastic container containing 40 ml water for control and 40 ml of 20% Formulation B.
Perforated paper towel was placed above (˜60 mm) from the liquid phase.
7 ml water was added on the paper towel to keep it wet for seed germination.
Every morning 5 ml of water was poured on the paper towel to keep it moist.
20 Chickpea seeds soaked overnight in water were placed on the wet perforated paper towel.
Whole system was covered with another identical plastic container as a lid and sealed with tape from the four sides.
Experiment was carried out at 30° C. in controlled temperature cabinet.

### Result:

After 5 days

| | | No of | No of | | |
|---|---|---|---|---|---|
| | | seeds | seeds | | Ave. Sprout |
| No | Treatment | Tested | Germinated | % Germination | Length (mm) |
| 1 | Control | 20 | 20 | 100 | 10 |
| 2 | B | 20 | 0 | 0 | — |

### Observation:

Healthy seed germination in control whereas no germination in Formulation B. Seeds were found darker in experimental treatment.

### Conclusion:

1. This experiment further confirms that vapour generated from the bottom of the container passed through the perforated paper above it and inhibited seed germination in a closed system.
2. Seeds became nonviable by (i) physical contact of pine oil formulation (ii) without physical contact of pine oil formulation but with the vapour generated from pine oil emulsion.
   Effect of Pine Oil Vapor on Seeds about to Germinate.

The objective of this study is to find out what happens to seeds that are about to germinate in the presence of pine oil vapour. This experiment can give information on the fate of just germinated or about to germinate seeds when they are exposed to pine oil vapour.

### Experimental Set Up:

Plastic container having paper towel at the bottom wetted with 10 ml water Small Plastic cap in the centre containing
10 ml water in control

### 10 ml Formulation B

20 Chick Pea seeds soaked in water for ˜40 hours kept on the paper towel (FIG. 5). Container was closed with the plastic lid and kept at 30° C.

### Result:

### After 2 Days

| | | No of | No of | % | | |
|---|---|---|---|---|---|---|
| | Treat- | seeds | seeds | Germi- | Ave. Sprout | |
| No | ment | Tested | Germinated | nation | Length (mm) | Remark |
| 1 | Control | 20 | 20 | 100 | 35 | Healthy |
| | | | | | | sprouting |
| 2 | B | 20 | 0 | 0 | 6 | Retarded |
| | | | | | | Sprouting |

### Observation:

1. Pine oil vapour exposed seeds showed retarded germination with change in seed color.
2. Tips of the experimental sprouts were brownish compared to very healthy and white in control.

### Conclusion:

1. Seeds did germinate in experimental treatment as time of exposure of vapour to the about to germinate seeds were very less.
2. Visually sprouting in the experimental treatment was retarded and further growth was inhibited by the presence of pine vapour.
3. It can be concluded from this experiment that if freshly germinated or about to germinate seeds when come in contact with pine vapor do not develop into a healthy plant.

### Summary

From all above experiments it can be concluded that pine vapour has a powerful seed inhibiting activity.

This set of experiments proves that vapour is efficacious at all stages of seed germination/development.

Seeds becoming dark in color may be due to absorption/penetration of vapour in to the outer coat of seed.

Pine vapor can be effectively efficacious in the freshly germinated or about to germinate seeds by stopping them to develop further. This attribute can be added advantage for the field scale performance of the product.

While the preferred embodiments of the invention have been described above, it will be recognized and understood that various modifications may be made therein, and the appended claims are intended to cover all such modifications which may fall within the spirit and scope of the invention.

1. A herbicide mixture comprising alpha terpinol and tall oil.

2. The herbicide according to claim 1 comprising 21-80% terpinol and 8-66% tall oil.

3. The herbicide according to claim 1 wherein the herbicide is a concentrate and is arranged to be diluted into a carrier.

4. The herbicide according to claim 3 wherein the carrier is water.

5. The herbicide according to claim 3 wherein the carrier is an oil.

6. The herbicide according to claim 1 further comprising a vapour retaining agent.

7. The herbicide according to claim 6 wherein the vapour retaining agent is cellulose.

8. A method of applying a herbicide comprising:
providing a mixture comprising alpha terpinol and tall oil; and
spraying the mixture onto a quantity of soil,
wherein a herbicidal vapour is released by the mixture over a period of time greater than 10 minutes.
